(19) United States
(12) Patent Application Publication
(10) Pub. No.: US 2023/0076028 A1
(43) Pub. Date: Mar. 9, 2023

(54) FLUIDIC DEVICE

(71) Applicant: SEIKO EPSON CORPORATION, TOKYO (JP)

(72) Inventors: Keita KUBO, Matsumoto-shi (JP); Chikara KOJIMA, Matsumoto-shi (JP); Tomohide ONOGI, Shiojiri-shi (JP); Mitsuru MIYASAKA, Shiojiri-shi (JP)

(21) Appl. No.: 17/929,820

(22) Filed: Sep. 6, 2022

(30) Foreign Application Priority Data
Sep. 3, 2021 (JP) 2021-144010

(51) Int. Cl. F15D 1/00

(52) U.S. Cl. CPC F15D 1/007

(57) ABSTRACT

A fluidic device includes a channel in which a fluid flows, and an ultrasonic element generating standing wave in the fluid within the channel by applying ultrasonic wave to the fluid, wherein the channel has a first portion formed using a resin material having a first reflectance of ultrasonic wave propagating in the fluid less than a predetermined value and a second portion having a second reflectance of ultrasonic wave propagating in the fluid equal to or more than the predetermined value, and the second portion is placed on two different surfaces along a flow direction of the fluid within the channel.

The present application is based on, and claims priority from JP Application Serial Number 2021-144010, filed Sep. 3, 2021, the disclosure of which is hereby incorporated by reference herein in its entirety.

### BACKGROUND

### 1. Technical Field

The present disclosure relates to a fluidic device.

### 2. Related Art

In related art, a fluidic device acoustically focusing microparticles in a fluid is known.

For example, a fluidic device disclosed in a non-patent document, Nobutoshi Ota and six others, “Enhancement in acoustic focusing of micro and nanoparticles by thinning a microfluidic device”, December 2019, Royal Society Open Science, Volume 6, Issue 2, Article Number 181776, includes a channel substrate (glass substrate) in which a channel is formed and a piezoelectric element provided on the channel substrate. Ultrasonic wave generated in the piezoelectric element is transmitted into the channel via the channel substrate and generates standing wave in the fluid within the channel. Microparticles in the fluid are focused in a predetermined range within the channel by a pressure gradient of the fluid formed by the standing wave.

In the non-patent document, as a material forming the fluidic device, a hard material such as glass or metal that efficiently propagates acoustic wave is used. However, there is a problem that the manufacturing cost for microfabrication or the like of the material such as glass or metal is higher.

### SUMMARY

A fluidic device of a first aspect according to the present disclosure includes a channel in which a fluid flows, and an ultrasonic element generating standing wave in the fluid within the channel by applying ultrasonic wave to the fluid, wherein the channel has a first portion formed using a resin material having reflectance of ultrasonic wave propagating in the fluid less than a predetermined value and a second portion having the reflectance of the ultrasonic wave propagating in the fluid equal to or more than the predetermined value, and the second portion is placed on two different planes along a flow direction of the fluid within the channel.

In the fluidic device of the first aspect, it is preferable that Z₁/Z_{f} is less than 2.3, where acoustic impedance of the first portion is Z₁ and acoustic impedance of the fluid is Z_{f}.

In the fluidic device of the first aspect, it is preferable that Z₂/Z_{f} is equal to or more than 2.3, where acoustic impedance of the second portion is Z₂ and acoustic impedance of the fluid is Z_{f}.

In the fluidic device of the first aspect, it is preferable that the second portion is formed using metal or glass.

In the fluidic device of the first aspect, it is preferable that the fluid is water.

### BRIEF DESCRIPTION OF THE DRAWINGS

FIG. 1 is a sectional view schematically showing a part of a fluidic device of an embodiment.

FIG. 2 is a sectional view along line A-A as seen in a direction of arrows in FIG. 1.

FIG. 3 is a perspective view showing a schematic configuration in a position where standing wave of the fluidic device of the embodiment is formed.

FIG. 4 shows reflectance Rp of ultrasonic wave with respect to water on a channel surface.

FIG. 5 is a schematic diagram showing another configuration example of a particle capture section in the fluidic device according to Modified Example 1.

FIG. 6 is a schematic diagram showing another configuration example of the particle capture section in the fluidic device according to Modified Example 3.

FIG. 7 is a schematic diagram showing another configuration example of the particle capture section in the fluidic device according to Modified Example 4.

FIG. 8 is a schematic diagram showing another configuration example of the particle capture section in the fluidic device according to Modified Example 4.

FIG. 9 is a schematic diagram showing another configuration example of the particle capture section in the fluidic device according to Modified Example 5.

FIG. 10 is a schematic diagram showing another configuration example of the particle capture section in the fluidic device according to Modified Example 5.

### DESCRIPTION OF EXEMPLARY EMBODIMENTS

As below, a fluidic device of one embodiment will be explained.

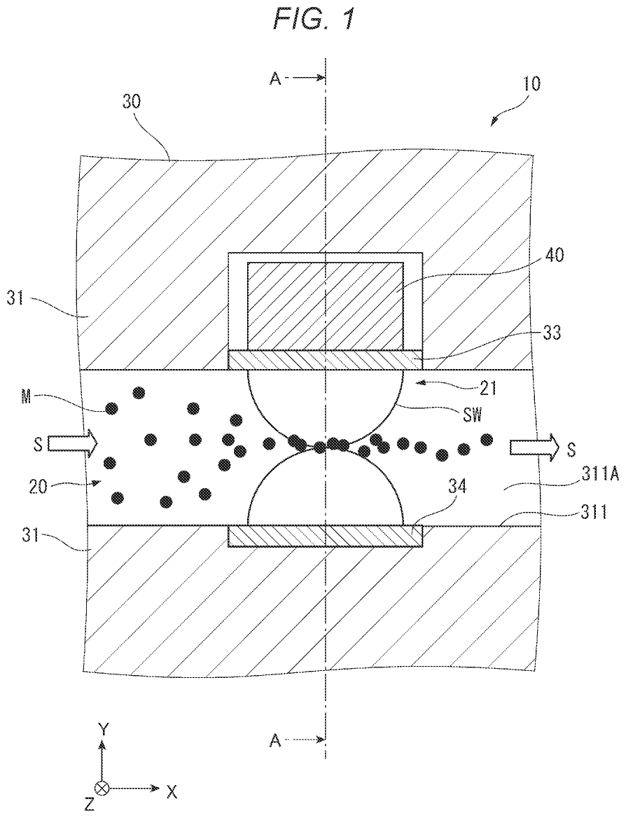

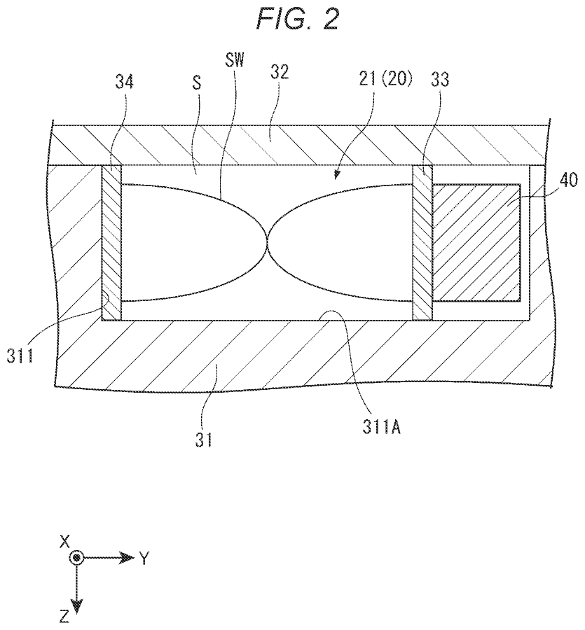

FIG. 1 is a sectional view schematically showing a part of a fluidic device 10 of the embodiment, and FIG. 2 is a sectional view along line A-A as seen in a direction of arrows in FIG. 1.

The fluidic device 10 includes a channel substrate 30 in which a channel 20 etc. are formed inside and an ultrasonic wave application unit 40 provided in the channel substrate 30.

In the fluidic device 10, the ultrasonic wave application unit 40 applies ultrasonic wave to a fluid S circulating in the channel 20, and thereby, generates standing wave SW of an arbitrary mode order along one direction orthogonal to the circulation direction of the fluid S. Microparticles or microfibers (hereinafter, referred to as “microparticles M”) dispersed in the fluid S are affected by a pressure gradient formed by the standing wave SW in the process of circulation within the channel 20 and focused in a predetermined range within the channel 20.

In the fluidic device 10, for example, of the channel 20, a concentration channel in which the fluid S in the range in which the microparticles M are focused is selectively flowd and an ejection channel in which the fluid S in the other range is selectively flowd are provided and the concentration of the microparticles M in the fluid S may be increased.

Note that, in FIG. 1, the microparticles M focused by the standing wave SW in the first-order mode are schematically exemplified. Further, in FIG. 2, the microparticles M are omitted and the standing wave SW generated within the channel 20 is shown as a pressure waveform.

In the following description, the flow direction of the fluid S flowing in the channel 20 is an X direction, a direction orthogonal to the X direction is a Y direction, and a direction orthogonal to the X direction and the Y direction is a Z direction.

### Configuration of Fluidic Device 10

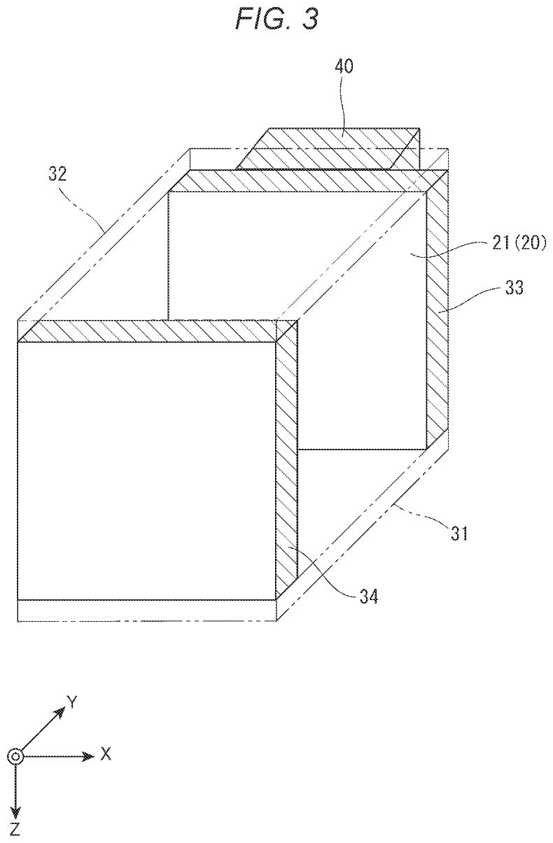

FIG. 3 is a perspective view showing a schematic configuration of the channel 20 in a position where the standing wave SW of the fluidic device 10 of the embodiment is formed (particle capture section 21).

The channel substrate 30 is a substrate in which the channel 20 is formed and, as shown in FIGS. 1 to 3, includes e.g. a base plate 31, a lid plate 32 (see FIGS. 2 and 3), a first wall portion 33, and a second wall portion 34. Note that, in FIG. 3, the first wall portion 33 and the second wall portion 34 having higher reflectance of ultrasonic wave are shown by solid lines and the base plate 31 and the lid plate 32 having lower reflectance of ultrasonic wave are shown by dashed lines.

A concave groove 311 concave toward the +Z side is provided along the X direction in the base plate 31, the concave groove 311 is covered by the lid plate 32, and thereby, the closed channel 20 for circulation of the fluid S is formed.

Further, the width of the concave groove 311 in the Y direction is formed to be larger in correspondence with the formation position of the standing wave SW. In the portion with the larger width of the concave groove 311 in the Y direction, the ultrasonic wave application unit 40, the first wall portion 33, and the second wall portion 34 are placed in the Y direction. The first wall portion 33 and the second wall portion 34 facing in the Y direction and the lid plate 32 and a bottom surface 311A of the concave groove 311 facing in the Z direction form the channel 20. Hereinafter, of the channel 20, a section formed by surrounding with the bottom surface 311A, the lid plate 32, the first wall portion 33, and the second wall portion 34, in which the microparticles M are captured by generation of the standing wave SW is referred to as “particle capture section 21”.

The base plate 31 and the lid plate 32 are formed using resin materials. Accordingly, the above described concave groove 311 may be formed more easily and accurately using a molding method such as injection molding.

The first wall portion 33 and the second wall portion 34 are planar plates and placed to face each other with the channel 20 in between so that a surface of the first wall portion 33 facing the second wall portion 34 and a surface of the second wall portion 34 facing the first wall portion 33 may be parallel. These first wall portion 33 and second wall portion 34 form a second portion according to the present disclosure and serve as surfaces reflecting ultrasonic wave when the standing wave SW is formed with respect to the fluid S.

Here, regarding the particle capture section 21 in which the standing wave SW is formed, the channel 20 is formed by surrounding with the bottom surface 311A of the concave groove 311, the lid plate 32, the first wall portion 33, and the second wall portion 34. The bottom surface 311A and the lid plate 32 face each other in the Z direction in parallel. The first wall portion 33 and the second wall portion 34 face each other in the Y direction as described above. The bottom surface 311A and the lid plate 32 correspond to a first portion in the present disclosure and the first wall portion 33 and the second wall portion 34 correspond to the second portion in the present disclosure.

In the other part than the particle capture section 21, the channel 20 is formed by the concave groove 311 of the base plate 31 and the lid plate 32 covering the concave groove 311.

Next, the materials forming the base plate 31, the lid plate 32, the first wall portion 33, and the second wall portion 34 will be explained in more detail.

When the acoustic impedance of the base plate 31 and the lid plate 32 is respectively Z₁ and the acoustic impedance of the fluid S is Z_{f}, reflectance Rₚ₁ of the base plate 31 and the lid plate 32 may be expressed by the following expression (1).

Rₚ₁=(Z₁−Z_{f})/(Z₁+Z_{f}) (1)

In the embodiment, the base plate 31 and the lid plate 32 are formed using the material satisfying Rₚ₁<0.4. In other words, the material of the base plate 31 and the lid plate 32 is set for the fluid S flowing in the channel 20 so that a ratio of acoustic impedance Z₁/Z_{f} may be less than 2.3. Note that the base plate 31 and the lid plate 32 may be formed using different materials as long as the materials satisfy the expression (1).

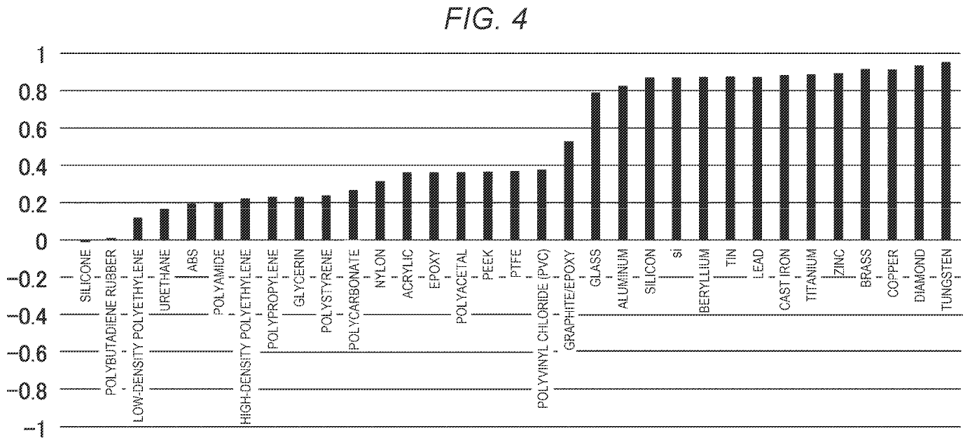

FIG. 4 shows reflectance Rp of ultrasonic wave with respect to water on a channel surface.

As shown in FIG. 4, when the fluid is water, as the base plate 31 and the lid plate 32, various resin materials including silicone, polybutadiene rubber, polyethylene, urethane, ABS, polyamide, polystyrene, polycarbonate, nylon, acrylic, epoxy, polyacetal, PEEK, PTFE, and PVC may be used.

On the other hand, when the acoustic impedance of the first wall portion 33 and the second wall portion 34 is Z₂, reflectance Rₚ₂ of the first wall portion 33 and the second wall portion 34 may be expressed by the following expression (2).

Rₚ₂=(Z₂−Z_{f})/(Z₂+Z_{f}) (2)

In the embodiment, the first wall portion 33 and the second wall portion 34 are formed using the material satisfying Rₚ₂≥0.4. In other words, the material of the first wall portion 33 and the second wall portion 34 is set for the fluid S flowing in the channel 20 so that a ratio of acoustic impedance Z₂/Z_{f} may be equal to or more than 2.3. Note that the first wall portion 33 and the second wall portion 34 may be formed using different materials as long as the materials satisfy the expression (2).

As shown in FIG. 4, when the fluid is water, as the first wall portion 33 and the second wall portion 34, glass or various resin materials may be used.

### Configuration of Ultrasonic Wave Application Unit 40

The ultrasonic wave application unit 40 is an ultrasonic element transmitting acoustic wave. As the ultrasonic wave application unit 40, e.g. a unit vibrating a piezoelectric actuator, a unit vibrating a vibrating plate, or the like may be used.

For example, the unit vibrating a piezoelectric actuator applies a drive voltage to the piezoelectric actuator, vibrates the piezoelectric actuator itself, and generates acoustic wave. As the unit vibrating a vibrating plate, a piezoelectric thin film is formed on a vibrating plate in a thin plate shape, a voltage is applied to the piezoelectric thin film and the vibrating plate is vibrated, and acoustic wave is generated by vibration of the vibrating plate. Or, an electrostatic actuator may be formed by placement of electrodes on a vibrating plate and a substrate facing the vibrating plate. In this case, a periodic drive voltage is applied between the electrodes, and thereby, the vibrating plate is vibrated and acoustic wave is generated.

Note that acoustic pressure is proportional to the square of the frequency, and thus, it is preferable to use ultrasonic wave as the acoustic wave for efficiently capturing the microparticles M at the node of the standing wave SW within the channel 20.

In a low frequency range of ultrasonic wave, e.g. a frequency range from 10 kHz to 300 kHz, cavitation occurs in the fluid S and the frequency range is unsuitable for capture of the microparticles M in the fluid S. Therefore, it is preferable that the ultrasonic wave application unit 40 of the embodiment applies ultrasonic wave having a frequency equal to or higher than 300 kHz. Note that the upper limit of the frequency of the oscillated ultrasonic wave is not particularly limited, but a frequency higher than 50 MHz is not general as a drive frequency for driving a drive source such as a piezoelectric actuator. Therefore, it is preferable to use a unit generating ultrasonic wave in a frequency range from 300 kHz to 50 MHz as the ultrasonic wave application unit 40.

In FIGS. 1 to 3, the configuration example in which the ultrasonic wave application unit 40 and the first wall portion 33 are separately provided is shown and the example in which the ultrasonic wave is propagated from the ultrasonic wave application unit 40 to the fluid S via the first wall portion 33 is shown. In this case, it is desirable that the acoustic impedance of the ultrasonic wave application unit 40 is close to the acoustic impedance of the first wall portion 33. This is for preventing the reflection of the acoustic wave introduced from the ultrasonic wave application unit 40 by the first wall portion 33. Further, the configuration in which the first wall portion 33 intervenes between the ultrasonic wave application unit 40 and the fluid is exemplified, however, not limited to that. For example, a configuration in which the transmission surface of ultrasonic wave of the ultrasonic wave application unit 40 forms the first wall portion 33 may be employed. Thereby, the acoustic impedance of the ultrasonic wave application unit 40 and the acoustic impedance of the first wall portion 33 are substantially equal, and ultrasonic wave may be efficiently introduced into the fluid S.

For example, when a vibrating plate is vibrated by the piezoelectric thin film or the electrostatic actuator, the vibrating plate may be formed as the first wall portion 33 in contact with the channel 20. As the vibrating plate, a plate having the ratio of acoustic impedance Z₂/Z_{f} equal to or more than 2.3 may be selected. For example, an Si substrate or the like may be used.

Furthermore, in the embodiment, the example in which the ultrasonic wave application unit 40 is provided at the first wall portion 33 side is shown, however, the unit may be provided at the second wall portion 34 side or the transmission surface of ultrasonic wave of the ultrasonic wave application unit 40 may be formed as the second wall portion 34 in contact with the channel 20.

Standing Wave generated in Channel 20

The ultrasonic wave is applied by the ultrasonic wave application unit 40, and thereby, as shown in FIGS. 1 and 2, the standing wave SW is generated in the fluid S.

Here, when the channel width in the Y direction as the direction in which the standing wave SW is generated is W (m), the sound velocity in the fluid S is c (m/s), and the mode order of the standing wave SW at a frequency f (Hz) of the ultrasonic wave applied by the ultrasonic wave application unit 40 is N, a condition for generation of the standing wave SW is the following expression (3).

W=N×c/2f (3)

Here, in the embodiment, as shown in FIGS. 2 and 3, in the formation position of the standing wave SW in the channel 20, the channel 20 is formed by the base plate 31 and the lid plate 32 formed using the resin material having the reflectance of ultrasonic wave less than 0.4 and the first wall portion 33 and the second wall portion 34 having the reflectance of ultrasonic wave equal to or more than 0.4.

In this case, the standing wave SW having a large acoustic pressure gradient is formed by the ultrasonic wave reflected by the first wall portion 33 and the second wall portion 34 having higher ultrasonic wave reflection properties. On the other hand, the amount of transmission of the ultrasonic wave is larger than the amount of reflection between the bottom surface 311A of the concave groove 311 of the base plate 31 and the lid plate 32. Accordingly, the formation of standing wave is suppressed between the bottom surface 311A and the lid plate 32. If the standing wave is formed between the bottom surface 311A and the lid plate 32, the reflectance of ultrasonic wave is lower and the acoustic pressure of the reflected ultrasonic wave is lower in the bottom surface 311A and the lid plate 32 made of resin. Therefore, even when the standing wave is generated between the bottom surface 311A and the lid plate 32, the standing wave has the lower maximum acoustic pressure at the antinode and the smaller acoustic pressure gradient than the standing wave SW generated between the first wall portion 33 and the second wall portion 34, and the influence on the standing wave SW generated between the first wall portion 33 and the second wall portion 34 may be made smaller.

As the frequency of ultrasonic wave is lower, the directionality of ultrasonic wave is lower and the ultrasonic wave spreads and propagates around as spherical wave. In this case, the ultrasonic wave may be repeatedly reflected not only between two surfaces facing each other but also between two surfaces crossing each other. For example, the ultrasonic wave is repeatedly reflected between the first wall portion 33 and the bottom surface 311A, between the first wall portion 33 and the lid plate 32, between the second wall portion 34 and the bottom surface 311A, and between the second wall portion 34 and the lid plate 32. However, the base plate 31 forming the bottom surface 311A and the lid plate 32 are formed using the resin material and have smaller reflectance of ultrasonic wave than the first wall portion 33 and the second wall portion 34. Therefore, the ultrasonic wave reflected by the first wall portion 33 and the second wall portion 34 and the ultrasonic wave reflected by the bottom surface 311A and the lid plate 32 are largely different in acoustic pressure and standing wave is not generated.

As described above, in the embodiment, the standing wave SW is formed between the first wall portion 33 and the second wall portion 34 and generation of other standing wave is suppressed. Thereby, the microparticles M in the fluid S may be preferably captured by the standing wave SW. If other standing wave is generated, the acoustic pressure at the antinode is lower and the particle capturing function by the difference in acoustic pressure between the antinode and the node is lower than those of the standing wave SW between the first wall portion 33 and the second wall portion 34. That is, even when other standing wave is generated, hindrance to the particle capturing function by the standing wave SW between the first wall portion 33 and the second wall portion 34 may be suppressed.

### Effects of Embodiment

The fluidic device 10 of the embodiment includes the channel 20 in which the fluid S flows and the ultrasonic wave application unit 40 generating the standing wave SW in the fluid S within the channel 20 by applying ultrasonic wave to the fluid S. The channel 20 has the base plate 31 and the lid plate 32 formed using the resin material having the reflectance of ultrasonic wave propagating in the fluid S less than the predetermined value and the first wall portion 33 and the second wall portion 34 having the reflectance equal to or more than the predetermined value, and the first wall portion 33 and the second wall portion 34 are placed on two surfaces along the flow direction of the fluid S within the channel 20.

In the embodiment, when ultrasonic wave is applied from the ultrasonic wave application unit 40 to the fluid S, the standing wave SW is generated between the first wall portion 33 and the second wall portion 34 having the reflectance equal to or more than the predetermined value, and the microparticles M within the fluid S may be captured at the node of the standing wave SW.

On the other hand, the bottom surface 311A of the concave groove 311 of the base plate 31 and the lid plate 32 forming the channel 20 of the fluidic device 10 and corresponding to the first portion according to the present disclosure are formed using the resin material having the reflectance of ultrasonic wave less than the predetermined value. The cost of the material and machining of the material for the base plate 31 and the lid plate 32 formed using the resin material may be reduced. For example, when the entire of the fluidic device 10 is formed using a hard material such as metal or glass, machining processing for formation of the micro channel 20 becomes complex and the production cost of the machining becomes higher. On the other hand, in the embodiment, the base plate 31 is formed using the resin material and the concave groove 311 for formation of the channel 20 may be easily formed by e.g. injection molding or the like and the manufacturing cost may be significantly reduced.

In addition, the base plate 31 and the lid plate 32 formed using the resin material have the lower reflectance of ultrasonic wave and generation of other ultrasonic wave hindering the formation of the standing wave SW may be suppressed. For example, when the bottom surface 311A and the lid plate 32 are formed using metal or the like, standing wave along the Z direction may be formed in addition to the standing wave SW along the Y direction. In this case, the acoustic pressure gradient by the other standing wave is added to the acoustic pressure gradient by the standing wave SW and the acoustic pressure distribution becomes complex, and the force for capturing the microparticles M in a predetermined position may be weaker. On the other hand, in the embodiment, generation of other ultrasonic wave than the standing wave SW by the first wall portion 33 and the second wall portion 34 may be suppressed and the capturing function of the microparticles M by the fluidic device 10 may be improved.

In the fluidic device 10 of the embodiment, when the acoustic impedance of the base plate 31 and the lid plate 32 forming the first portion is Z₁ and the acoustic impedance of the fluid S is Z_{f}, Z₁/Z_{f} is less than 2.3.

Thereby, the reflectance of ultrasonic wave in another part than the first wall portion 33 and the second wall portion 34 may be appropriately reduced and the influence by other standing wave than the standing wave SW by the first wall portion 33 and the second wall portion 34 may be suppressed.

In the fluidic device 10 of the embodiment, when the acoustic impedance of the first wall portion 33 and the second wall portion 34 forming the second portion is Z₂, Z₂/Z_{f} is equal to or more than 2.3.

Thereby, the reduction in acoustic pressure of ultrasonic wave reflected by the first wall portion 33 and the second wall portion 34 may be suppressed and the difference between the maximum acoustic pressure at the antinode in the standing wave SW and the acoustic pressure at the node of the standing wave SW may be made larger. Therefore, the microparticles M may be appropriately captured at the node of the standing wave SW.

In the fluidic device 10 of the embodiment, the second portion as the first wall portion 33 and the second wall portion 34 is formed using metal or glass. The metal or glass has a large difference in acoustic impedance from a fluid such as water and may reflect ultrasonic wave propagating in the fluid S at higher reflectance. Therefore, the microparticles M may be appropriately captured at the node of the standing wave SW formed between the first wall portion 33 and the second wall portion 34.

In the fluidic device 10 of the embodiment, the fluid is water.

As shown in FIG. 4, when water is used as the fluid, the reflectance of ultrasonic wave may be less than 0.4 with respect to the first portion of the resin material and may be equal to or more than 0.4 with respect to the second portion formed using metal, glass, or the like.

Further, water is used as the fluid, and thereby, the fluidic device 10 that can appropriately separate the microparticles M contained in the water may be provided and the range of use may be made wider. For example, sewage-containing water drained from a washing machine or a kitchen is introduced into the fluidic device 10, and thereby, microparticles contained in the sewage-containing water may be separated. In this case, microplastic fibers contained in washing water, abrasive powder of a detergent contained in the sewage of the kitchen, etc. may be separated, and the environmental damage due to harmful substances such as plastic wastes can be suppressed.

### MODIFIED EXAMPLES

The present disclosure is not limited to the above described respective embodiments. The present disclosure includes configurations obtained by modifications and improvements within the scope that may achieve the purpose of the present disclosure and appropriate combinations of the respective embodiments.

### Modified Example 1

In the above described embodiment, the formation location of the standing wave SW of the channel 20 is formed by the first wall portion 33 and the second wall portion 34 facing in the Y direction with the channel 20 in between and parallel to each other and the bottom surface 311A of the concave groove 311 and the lid plate 32 facing in the Z direction, however, not limited to that.

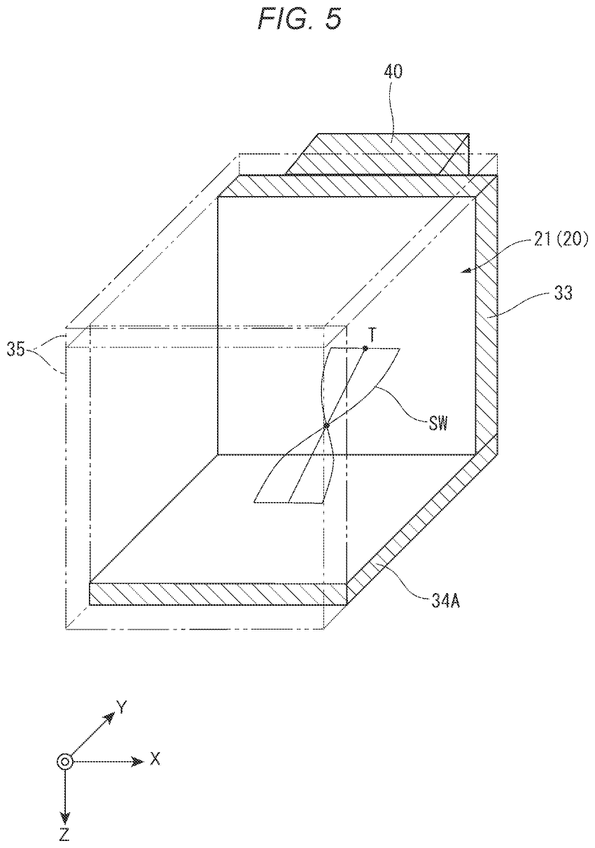

FIG. 5 is a schematic diagram showing a configuration example of the particle capture section 21 in Modified Example 1.

For example, as shown in FIG. 5, the first wall portion 33 and the second wall portion 34A forming the second portion may incline to each other. Note that, in FIG. 5, dashed lines show portions formed using a resin material in which standing wave is hard to be formed (resin portions 35).

In the example shown in FIG. 5, the first wall portion 33 is placed on the side surface at the +Y side of the channel 20 and the second wall portion 34A is placed at the +Z side of the channel 20, and thereby, the first wall portion 33 and the second wall portion 34A are placed adjacent to each other and orthogonal.

Like the above described embodiment, when the concave groove 311 along the channel 20 is formed in the base plate 31 and the lid plate 32 is placed to face the bottom surface 311A of the concave groove 311, the first wall portion 33 may be placed on the side surface at the +Y side of the concave groove 311 in the particle capture section 21 and the second wall portion 34A may be placed on the bottom surface 311A of the concave groove 311. In this case, the side surface at the −Y side of the concave groove 311 and the lid plate 32 form the resin portions 35.

As described above, as the frequency of ultrasonic wave applied by the ultrasonic wave application unit 40 is lower, the directionality is lower and the ultrasonic wave spreads and propagates throughout like spherical wave. Therefore, in the configuration shown in FIG. 5, the frequency is controlled, and thereby, the ultrasonic wave spreading like spherical wave from the first wall portion 33 reaches the second wall portion 34A and the ultrasonic wave reflected by the second wall portion 34A reaches the first wall portion 33. Therefore, standing wave SW may be formed between the first wall portion 33 and the second wall portion 34A.

Further, in this case, the distance from the first wall portion 33 to the second wall portion 34A changes depending on the position. Therefore, the position of the ultrasonic wave applied from the ultrasonic wave application unit 40 is set to one point in the first wall portion 33 (ultrasonic wave application position T) and the frequency of the ultrasonic wave is changed, and thereby, the formation position of standing wave may be controlled. That is, the standing wave SW is formed between a position in which the distance from the ultrasonic wave application position T satisfies the channel width W of the above described expression (3) of the second wall portion 34A and the ultrasonic wave application position T.

### Modified Example 2

In the above described embodiment, the example in which the ultrasonic wave application unit 40 is placed adjacent to the first wall portion 33 is shown, however, the placement is not limited to that. For example, the ultrasonic wave application unit 40 may be provided on the second wall portion 34 and apply ultrasonic wave from the second wall portion 34 as described above.

Further, when the frequency of the applied ultrasonic wave is lower than a predetermined value, the ultrasonic wave application unit 40 may be provided on the bottom surface 311A of the concave groove 311 or the lid plate 32. In this case, the ultrasonic wave applied into the fluid S spreads and propagates like spherical wave and standing wave SW may be formed by the ultrasonic wave reflected by the first wall portion 33 and the second wall portion 34.

### Modified Example 3

In the above described embodiment, the example in which the bottom surface 311A of the concave groove 311 of the base plate 31, the lid plate 32, the first wall portion 33, and the second wall portion 34 respectively contact the channel 20 in planar surfaces and form the rectangular channel 20 in the sectional view is shown, however, the configuration is not limited to that.

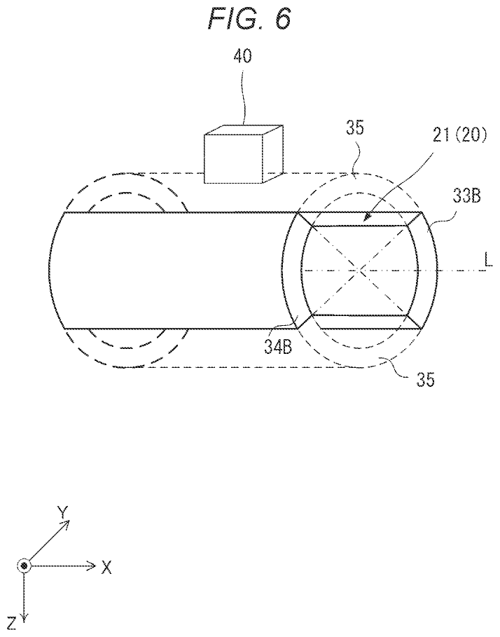

FIG. 6 is a schematic diagram showing another configuration example of the particle capture section 21.

For example, as shown in FIG. 6, the channel 20 may be formed in a cylindrical shape. In this case, surfaces of a first wall portion 33B and a second wall portion 34B in contact with the channel 20 are arc curved surfaces and placed to be point-symmetrical with respect to a center axis L of the channel 20. Further, the other portions than the first wall portion 33B and the second wall portion 34B are resin portions 35 having arc curved surfaces on the inner circumference formed using a resin material. In this case, for example, the channel width W and the frequency of ultrasonic wave applied from the ultrasonic wave application unit 40 may be set so that the center axis L may be a node of the standing wave SW.

### Modified Example 4

Furthermore, in the above described embodiment, the example in which the entire of a pair of XZ surfaces forming the channel 20 is the first wall portion 33 or the second wall portion 34 is shown, however, the configuration is not limited to that.

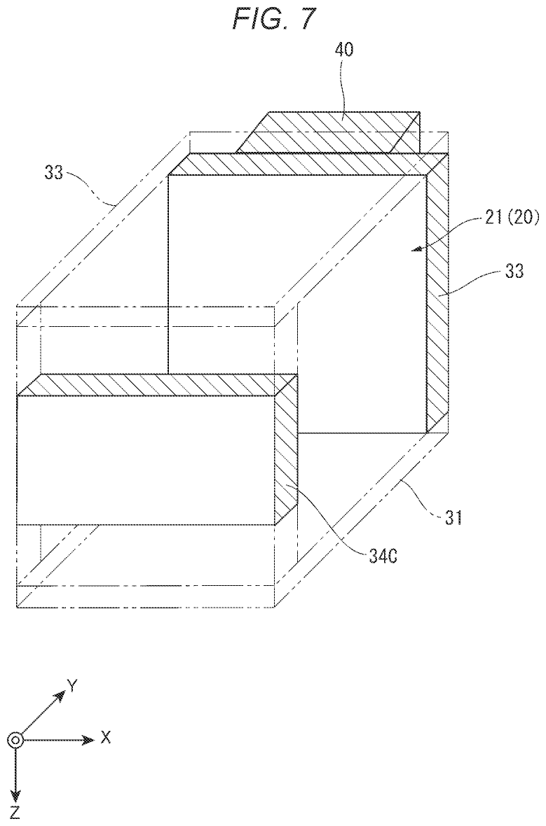

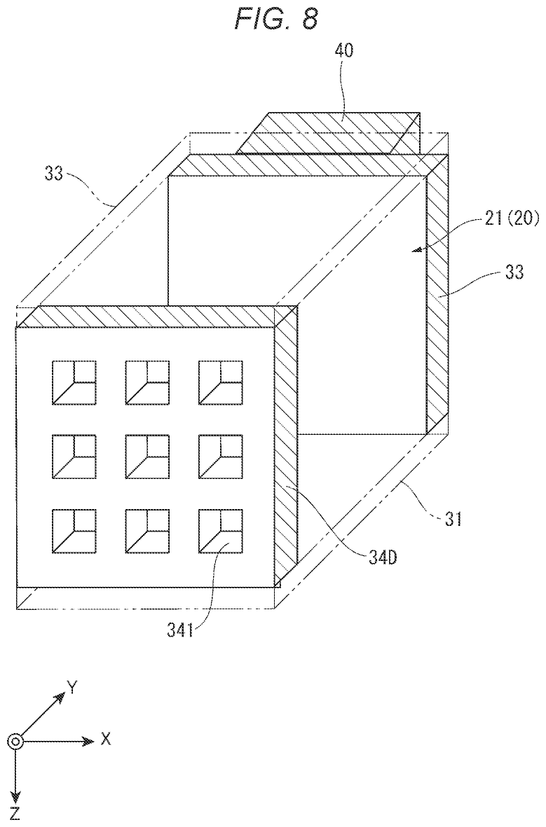

FIGS. 7 and 8 are schematic diagrams showing other configuration examples of formation locations of standing wave SW of the channel 20.

For example, as shown in FIGS. 7 and 8, only parts of the XZ surfaces forming the channel 20 may be second wall portions 34C, 34D.

In the example shown in FIG. 7, the second wall portion 34C is placed in only a center part along the X direction of the XZ surface at the −Y side in contact with the channel 20. That is, at the ±Z sides of the second wall portion 34C, resin portions formed using a resin material (e.g. the side surface of the concave groove 311 of the base plate 31) are placed.

In the example shown in FIG. 8, the second wall portion 34D in which a plurality of openings 341 are provided in the XZ surface at the −Y side of the channel 20, and the side wall of the concave groove 311 is exposed from the openings 341 of the second wall portion 34D or the openings 341 are filled with a resin material.

Note that the same applies to the first wall portion 33 and the first wall portion 33 may be provided in a part of the XZ surface at the +Y side in contact with the channel 20.

### Modified Example 5

In the above described embodiment, the example in which, in the sectional view of the channel 20 cut along the YZ-plane, the bottom surface 311A of the concave groove 311 and the first wall portion 33, the lid plate 32 and the first wall portion 33, the bottom surface 311A of the concave groove 311 and the second wall portion 34, and the lid plate 32 and the second wall portion 34 respectively cross each other at right angles is shown, however, the configuration is not limited to that.

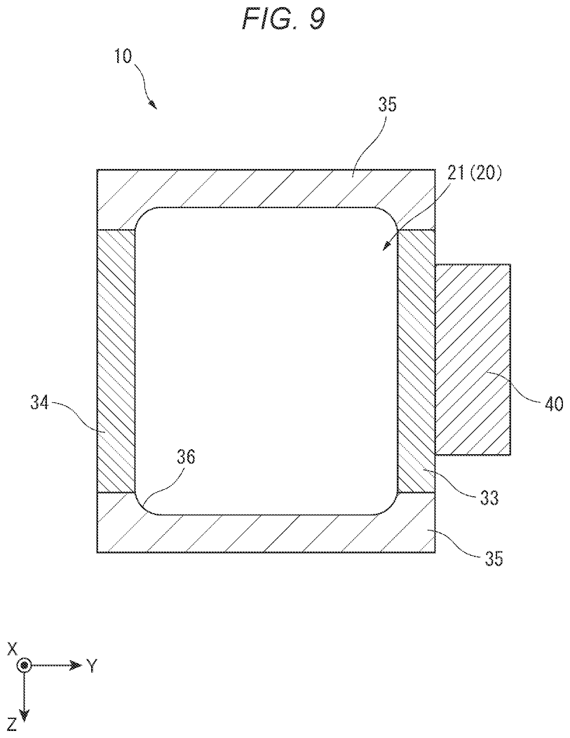

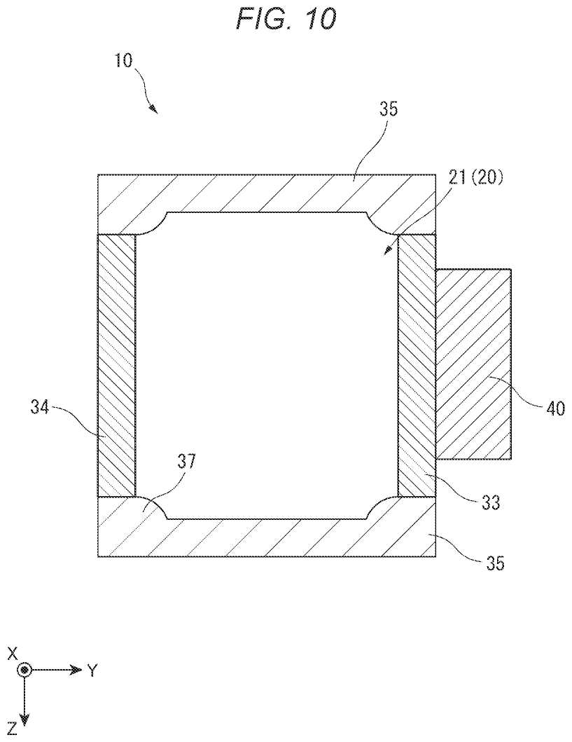

FIGS. 9 and 10 are schematic diagrams showing configuration examples of the particle capture section 21 of the channel 20.

That is, as in the above described embodiment, when the channel 20 is formed by four surfaces and the two surfaces cross at the right angles on the respective corner portions, ultrasonic wave may be complexly multiply reflected and the distribution of acoustic pressure may become complex.

On the other hand, as shown in FIGS. 9 and 10, arc surfaces may be respectively formed between the resin portions 35 forming the channel 20 (e.g. the bottom surface 311A and the lid plate 32) and the first wall portion 33 and the second wall portion 34. The arc surface may be e.g. a concave arc surface 36 convex from the channel 20 side toward outside as shown in FIG. 9 or a convex arc surface 37 convex toward inside as shown in FIG. 10. In this case, complex multiple reflection of ultrasonic wave in the respective corner portions may be suppressed.

### Modified Example 6

The example in which the base plate 31 and the lid plate 32 forming the first portion according to the present disclosure and the resin portions 35 are formed using the resin materials having the reflectance of ultrasonic wave less than 0.4 is shown, and an acoustic wave absorption portion absorbing acoustic wave may be provided in a surface of the first portion in contact with the channel 20.

### Modified Example 7

In the above described embodiment, the example in which the concave groove 311 is formed in the base plate 31, the first wall portion 33 is inserted into the side surface at the +Y side of the concave groove 311, and the second wall portion 34 is inserted into the side surface at the −Y side is shown, however, the configuration is not limited to that.

For example, the first wall portion 33 and the second wall portion 34 are placed on the base plate formed using the resin material and the lid plate 32 is placed with these first wall portion 33 and second wall portion 34 as spacers, and thereby, the particle capture section 21 may be formed. In the channel 20 except the particle capture section 21, the channel 20 may be formed by a pair of spacers formed using a resin material facing in the Y direction in place of the first wall portion 33 and the second wall portion 34, however, the first wall portion 33 and the second wall portion 34 may be placed like the particle capture section 21. Or, a base plate formed using a resin material may be molded in a tubular shape and the first wall portion 33 and the second wall portion 34 may be inserted into only necessary parts. Or, the base plate 31 and the lid plate 32 may have curved surfaces.

### Overview of Present Disclosure

A fluidic device of a first aspect according to the present disclosure includes a channel in which a fluid flows, and an ultrasonic element generating standing wave in the fluid within the channel by applying ultrasonic wave to the fluid, wherein the channel has a first portion formed using a resin material having reflectance of ultrasonic wave propagating in the fluid less than a predetermined value and a second portion having the reflectance of ultrasonic wave propagating in the fluid equal to or more than the predetermined value, and the second portion is placed on two different surfaces along a flow direction of the fluid within the channel.

Thereby, in the fluidic device, when ultrasonic wave is applied from the ultrasonic element to the fluid, standing wave is generated in the second portion of the different two surfaces having the reflectance equal to or more than the predetermined value, and microparticles within the fluid may be captured at the node thereof.

Further, the first portion is formed using the resin material having the reflectance of ultrasonic wave less than the predetermined value, and the channel in a desired shape can be easily formed by e.g. injection molding or the like and the manufacturing cost may be reduced.

In addition, the reflectance of ultrasonic wave is lower in the first portion and formation of another waveform hindering the acoustic pressure gradient of the standing wave formed by the second portion may be suppressed. Accordingly, the capturing function of the microparticles using the standing wave formed by the second portion may be improved.

In the fluidic device of the first aspect, Z₁/Z_{f} may be less than 2.3, where acoustic impedance of the first portion is Z₁ and acoustic impedance of the fluid is Z_{f}. Thereby, the reflectance of ultrasonic wave in the first portion may be appropriately reduced and the influence by other standing wave than the standing wave by the second portion may be suppressed.

In the fluidic device of the first aspect, Z₂/Z_{f} may be equal to or more than 2.3, where acoustic impedance of the second portion is Z₂ and the acoustic impedance of the fluid is Z_{f}.

Thereby, the reduction in acoustic pressure of ultrasonic wave reflected by the second portion may be suppressed and the difference between the maximum acoustic pressure at the antinode in the standing wave and the acoustic pressure at the node of the standing wave SW may be made larger. Therefore, the microparticles may be appropriately captured at the node of the standing wave.

In the fluidic device of the first aspect, the second portion may be formed using metal or glass.

The metal or glass has a large difference in acoustic impedance from a fluid such as water and may reflect the ultrasonic wave propagating in the fluid at higher reflectance. Therefore, the standing wave may be formed between the different two surfaces of the second portion, and the microparticles may be appropriately captured at the node of the standing wave.

In the fluidic device of the first aspect, the fluid may be water.

When water is used as the fluid, the reflectance of ultrasonic wave may be less than 0.4 with respect to the first portion of the resin material and may be equal to or more than 0.4 with respect to the second portion formed using metal, glass, or the like. Therefore, the degree of freedom of choice of the materials forming the fluidic device 10 may be increased and the manufacturing cost may be further reduced.

Further, water is used as the fluid, and thereby, the fluidic device that can appropriately separate the microparticles contained in the water may be provided and the range of use may be made wider. For example, sewage-containing water drained from a washing machine or a kitchen is introduced into the fluidic device, and thereby, microparticles contained in the sewage-containing water may be separated. In this case, microplastic fibers contained in washing water, abrasive powder of a detergent contained in the sewage of the kitchen, etc. may be separated, and the environmental damage due to harmful substances such as plastic wastes can be suppressed.

What is claimed is:

1. A fluidic device comprising:
a channel in which a fluid flows; and
an ultrasonic element generating standing wave in the fluid within the channel by applying ultrasonic wave to the fluid, wherein
the channel has a first portion formed using a resin material having a first reflectance of ultrasonic wave propagating in the fluid less than a predetermined value and a second portion having a second reflectance of ultrasonic wave propagating in the fluid equal to or more than the predetermined value, and
the second portion is placed on two different surfaces along a flow direction of the fluid within the channel.

2. The fluidic device according to claim 1, wherein
Z₁/Z_{f}<2.3, where acoustic impedance of the first portion is Z₁ and acoustic impedance of the fluid is Z_{f}.

3. The fluidic device according to claim 1, wherein
Z₂/Z_{f} 2.3, where acoustic impedance of the second portion is Z₂ and acoustic impedance of the fluid is Z_{f}.

4. The fluidic device according to claim 2, wherein
Z₂/Z_{f}≥2.3, where acoustic impedance of the second portion is Z₂ and acoustic impedance of the fluid is Z_{f}.

5. The fluidic device according to claim 3, wherein the second portion is formed using metal or glass.

6. The fluidic device according to claim 4, wherein the second portion is formed using metal or glass.

7. The fluidic device according to claim 1, wherein the fluid is water.

8. The fluidic device according to claim 2, wherein the fluid is water.

9. The fluidic device according to claim 3, wherein the fluid is water.

10. The fluidic device according to claim 4, wherein the fluid is water.

11. The fluidic device according to claim 5, wherein the fluid is water.

12. The fluidic device according to claim 6, wherein the fluid is water.
